(19) United States
(12) Patent Application Publication
(10) Pub. No.: US 2008/0005418 A1
(43) Pub. Date: Jan. 3, 2008

(54) Interactive interface for electronic devices

(76) Inventor: Jorge Julian, Los Angeles, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/431,110

(22) Filed: May 9, 2006

(51) Int. Cl. G06F 13/38

(52) U.S. Cl. 710/62

(57) ABSTRACT

The interactive interface for electronic devices includes a programmable processor connectable in communication with an electronic device for at least partially controlling operation of the electronic device and for monitoring operation of the electronic device, a memory connected to the processor for storing a program for operating the programmable processor, a user input device for accepting user input, the user input device connected to said programmable processor, and a display connected to the programmable processor. The interactive interface may be tethered to the electronic device by an electrical connector or by wireless communication.

### BACKGROUND OF THE INVENTION

This invention relates generally to an apparatus and method for training of users to operate electronic devices, and more particularly relates to an interactive interface apparatus for electronic devices.

Instructional materials and methods for electronic devices are increasingly inadequate, as today's electronic devices are being designed with more and more functions. For example, modern cellular phones not only provide telephone service, but also may include a video recorder, personal digital assistants (PDA), digital still camera, voice recorder, text messaging transceiver, picture messaging transceiver, MP3 player, calendar, alarm clock, calculator, game playing platform, text to speech input and feedback capability, polyphonic ring tone generator, GPS locator, screen saver, as well as wireless communication with headsets and computers and stereo speakers. Education and training for consumers learning to use such electronic devices is typically an open loop process, exemplified by a self-teaching process of reading of instructional materials such as an owners manual, and experimentation with the electronic device and learning by an extended period of trial and error. Opportunities for guided classroom instruction in the use of electronic devices are usually rare and are typically expensive.

Even classroom instruction for modern electronic devices can be inadequate. For example, traditionally film photography is taught to students in a class by a teacher who demonstrates with a camera, and presents sample photographs by overhead projection or video tapes for students to study. When explaining a photograph, the teacher may describe important attributes of the photograph, such as lighting, shadow, film speed, exposure, aperture, shutter speed, depth of field, camera angle, focal length, time of day, and film processing technique, for example. However, in order for students to learn camera control, students need to actually practice taking photographs, and after each shot, need to use a shooting data sheet to keep track of camera settings such as film speed, aperture, shutter speed, light quality, and then match this information later on with the photo-prints to see how the camera settings affected the photograph. This is a slow process and prone to errors, since it can be many hours or days before a photograph is developed after a photo shoot, and the accuracy of the notes are totally dependent on the observations, memory and diligence of the student in writing down the data immediately after taking the shot. In addition, when the instructor describes scenarios like “expose shadow, develop highlight,” “overexpose film rather than underexpose,” or “tricky lighting condition,” for example, it is difficult for students to understand such terms without an actual example to shoot right there in the classroom. The usual assignment is one photograph per week, and although students can, and in many cases want to do more, the need or desire to keep students of different skill levels and comprehension moving forward at the same pace makes it impractical, and in most cases impossible, to do more.

Traditional teaching methods thus make it difficult to provide adequate instruction using examples other than those in a classroom, because classes are typically indoors or in a studio. While there may be an occasional field trip, the majority of the classes will be held in a classroom.

An alternative to classroom instruction for learning photography and how to use a particular camera is self-teaching. Self-teaching materials for learning photography are available in many forms, such as instructional DVDs and VHS tapes, how-to books, seminars, and Internet based forums, for example. New cameras typically come with some form of instruction manual or electronic documentation. However, learning to use the basic features of a modern digital single reflex lens camera (DSLR) can also be a daunting prospect for a new user. For example, a current DSLR will typically have user selectable multiple focus modes, such as one shot auto focus, continuous autofocus, and manual focus; multiple metering modes, such as center weighted, evaluative, partial, and spot; autofocus points, white balance temperatures, ISO film speeds, white balance bracketing, variable blue, amber, magenta and yellow filters, exposure bracketing, aperture priority shooting mode, shutter priority shooting mode, and fully manual shooting mode.

Learning to use the basic features of other electronic devices such as home entertainment systems, universal remote controls, video recorders, PDAs, VCRs, digital video recorders, medical instrumentation, handheld calculators, electronic game consoles, and home appliances can also be overwhelming to a new user, since more and more features and options are continually being built into such devices. A user or owner's manual for these devices can range from a few pages to a PDF file on a CD that contains hundreds of electronic pages and/or multiple paper manuals covering hardware and software for the device. The more advanced such electronic devices become, the more likely it is that the average user will avoid reading the manual, and the more likely it is that they will decide to experiment with the device until they find or figure out what they need by trial and error. This oftentimes results in fewer and fewer users actually being able to locate and use the very features that prompted them to select and purchase the electronic device.

What is therefore needed for faster and better comprehension is a combination of an informative yet engaging method of instruction covering theoretical and practical photographic techniques, as well as viewable scenarios and examples, specific instructions dealing with all the features, functions and operational modes of a camera, and interactive examples of when and how to use individual features and functions. In addition, it would be desirable to have user selectable training exercises that the user can select and perform in sequence, as well as a means to search for and locate specific instructions or techniques when a particular need arises. Any and all exercises should be repeatable, but may also be presented in different ways so as not to become boring. It would also be desirable for each training exercise to involve recording and analyzing success and failure to provide feedback to help the user become more proficient in particular exercises.

When photographic images are captured on either film or tape, the opportunity for evaluation, review and feedback on the results is typically greatly delayed. Even with digital cameras using electronic image capture allowing for instant display of the results of operation of the camera, digital image capture has typically merely been another way of storing the images in electronic media such as compact flash cards, hard drives or optical disks, for later viewing and possible editing.

As a way of training new users and introducing camera features to new users, one digital camera operating system provides a menu driven context assistant to assist the user with the operation of both basic and advanced features of the digital camera. The context assistant permits a menu driven dialogue between the digital camera and the user through which instructions are provided for operation of the camera, based on an analysis of image data as well as the user input as to the context in which the digital camera is being used. The operating system can also perform actions, such as changing the camera's settings, or asking the user to do so. Another known camera operating system involves capturing an image with a camera set in an initial configuration, analyzing the parameters of the image and matching the parameters to one or more suggested capture configurations to define suggestions for improvement of the image in a later image recapture. One of the suggestions can be selected, and the camera then sets a configuration for another image capture according to the suggestion selected.

To provide more of a guided instructional approach for new users of appliances, one instructional system provides a graphical user interface for interactive product and service manuals for appliances such as a washing machine, through a computer program implemented via a connection to a network, a computer, or a wireless handheld device, which may include memory, mass storage, and data processing capabilities to display information. A hierarchical view displays a hierarchical relationship of a currently selected object with respect to parent and child components, and an information view provides information relevant to a selected subject.

It would be desirable to provide a way for new users of an electronic device to quickly allow automatic review and evaluation of the results operation of the electronic device, such as a digital camera, for example, with guided instruction. With the complexity of cameras today, and with ever-changing systems for focusing, selecting metering modes, and other new additional functions, and the increasing complexity of modern electronic devices in general, new users and even professionals need to pore through user manuals and seek assistance in learning how and when to use certain features. Depending on a user's level of experience, it would be desirable to provide an interactive interface that makes use of direct communication through the interactive interface with an electronic device, whether the interactive interface is tethered to the electronic device by an electrical connector or wireless communication, to facilitate the learning of basic function as well as advanced features and functions. The present invention meets these and other needs.

### SUMMARY OF THE INVENTION

Briefly and in general terms, the present invention provides for an apparatus and method that allows a user to interactively interface with an electronic device, providing a closed loop instructional chain that includes the electronic device, the user, the interactive interface apparatus, and a screen or display, allowing for monitoring of the user's responses and prompting with immediate feedback, to provide improved interactive instruction to users of electronic devices. The present invention accordingly provides for interactive interface, including a programmable processor connectable in communication with an electronic device for at least partially controlling operation of the electronic device and for monitoring operation of the electronic device, a memory for storing a program for operating the programmable processor, a user input device for accepting user input, and a display.

In a presently preferred aspect, the interactive interface is a tethered interface, and the programmable processor is connectable to the electronic device by an electrical connector, or by wireless communication, for example, and the programmable processor may be provided with a plurality of predetermined parameters input by the user input device. In a presently preferred aspect, the display provides a plurality of instruction menu items, and the user input device is operative to accept user input for selecting at least one of the plurality of instruction menu items, whereby the programmable processor can also monitor user input.

In another presently preferred aspect, the interactive interface provides a simulation of the electronic device on the display, such as an animated simulation, or a movie, such as of someone operating the electronic device, for example. Typically the animated simulation or movie provide visual indications of at least a portion of the electronic device required to accomplish a selected function. Where the electronic device is subject to subscription service charges for operation of the electronic device, the programmable processor can control the electronic device in a simulation mode that avoids subscription charges. In another presently preferred aspect of the invention, the interactive interface provides audio feedback responsive to the user input and operation of the electronic device.

In a presently preferred embodiment, the programmable processor is provided in a computer, the electronic device comprises a camera, such as a digital camera, and the interactive interface provides instruction and evaluation of operation of the digital camera, such as for operation of the digital camera for a plurality of scenes, or for a plurality of photographic opportunities, for example. In addition, the interactive interface may receive exchangeable image file format information from the digital camera, so that the programmable processor may be in turn operative to provide instruction and evaluation of operation of the digital camera responsive to the exchangeable image file format information. In a presently preferred aspect, the digital camera includes an internal clock and an operating system that generates time codes, so that the interactive interface can synchronize the time codes with operation of the digital camera for evaluation of the operation of the digital camera. The digital camera may also include an input/output interface capable of real-time or near real-time image data capture and transfer, such that the interactive interface can provide closed loop evaluation and instruction responsive to operation of the digital camera.

The present invention also provides for a method for at least partially controlling an electronic device and for monitoring operation of the electronic device via the interactive interface by providing the interactive interface, operatively connecting the interactive interface to the electronic device, displaying a plurality of instruction menu items on the display, receiving user input from the user input device to allow a user to select at least one of the plurality of instruction menu items provided on the display, and displaying a simulation of operation of the electronic device to accomplish a selected function. In a presently preferred aspect, the method also provides for monitoring the user input. A simulation of operation of the electronic device to accomplish a selected function may be displayed, and may include providing audio instruction responsive to the user input. The electronic device may include an internal clock and an operating system that generates time codes, so that the method may include synchronizing of the time codes with operation of the electronic device for evaluation of the operation of the electronic device. In another presently preferred aspect, the method of the invention provides for closed loop instruction responsive to operation of the electronic device. The method of the invention may also include storing a user defined function in the interactive interface, and may further include uploading such a user defined function to an Internet web site. In an other presently preferred embodiment, the method of the invention allows for performing remote diagnostics on the electronic device via the interactive interface.

Other features and advantages of the present invention will become more apparent from the following detailed description of the preferred embodiments in conjunction with the accompanying drawings, which illustrate, by way of example, the operation of the invention.

### BRIEF DESCRIPTION OF THE DRAWINGS

FIG. 1 is a schematic diagram illustrating a preferred embodiment of the interactive interface for use with an electronic device, via an electrical connection, according to the present invention.

FIG. 2 is a schematic diagram illustrating an alternate embodiment of the interactive interface for use with an electronic device, via wireless communication, according to the present invention.

FIG. 3 is a schematic diagram of a variant of the interactive interface utilizing an external display, according to the present invention.

FIG. 4 is a schematic diagram illustrating a digital camera for use with the interactive interface according to the present invention.

### DETAILED DESCRIPTION OF THE PREFERRED EMBODIMENTS

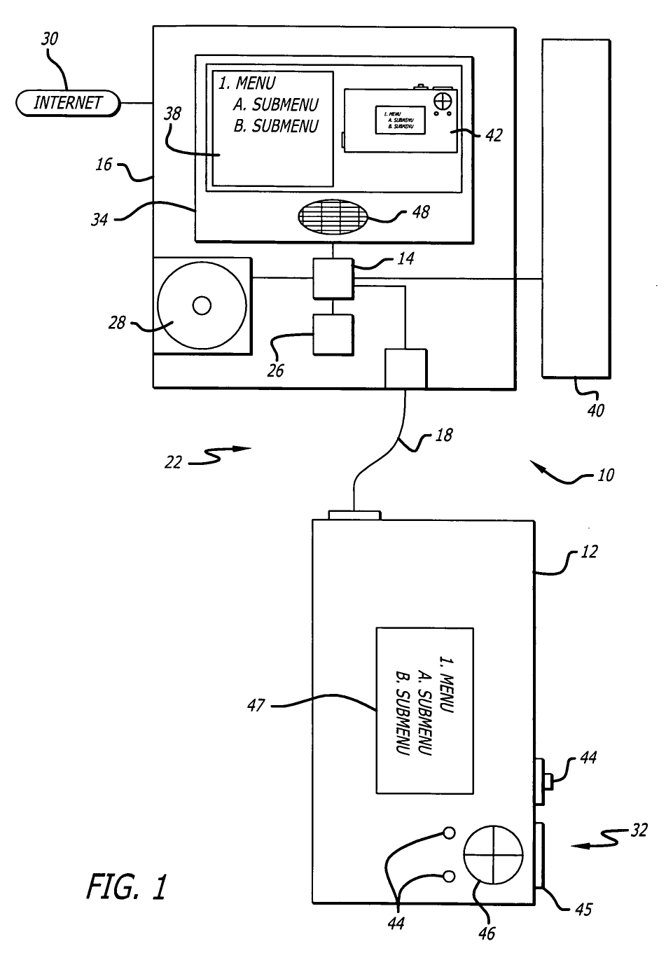

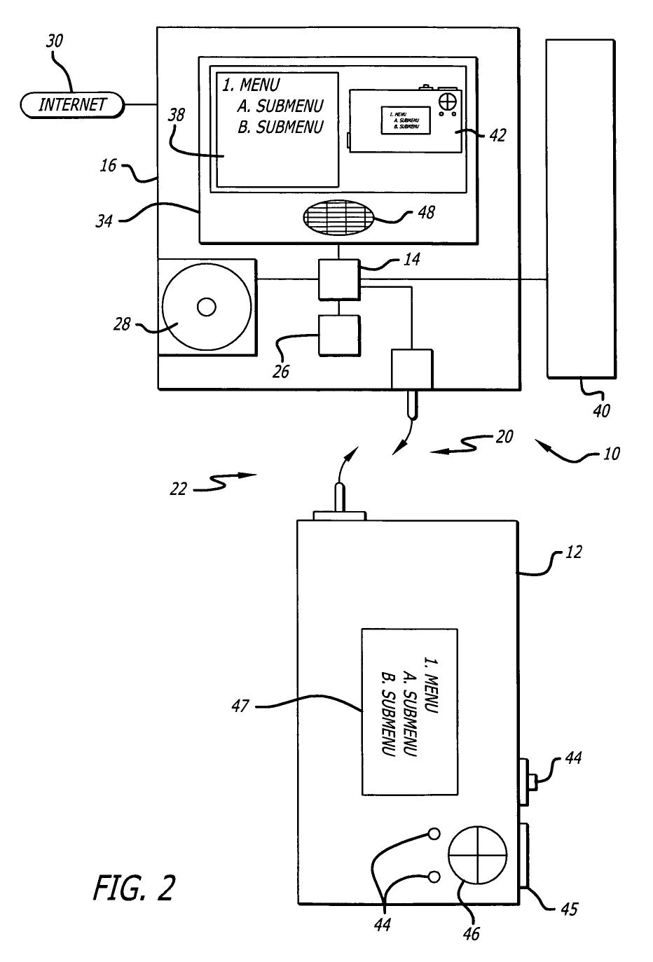

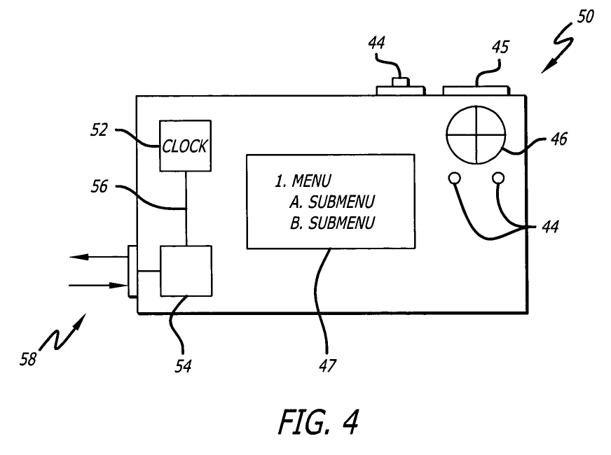

Referring to the drawings, which are provided for purposes of illustration and by way of example, the present invention provides for an interactive interface apparatus 10 for an electronic device 12. Referring to FIGS. 1 and 2, the interactive interface apparatus includes a programmable processor 14, such as in a computer 16, for example, connectable in communication with the electronic device for at least partially controlling operation of the electronic device and for monitoring operation of the electronic device. The interactive interface apparatus can be connectable to the electronic device by an electrical connector 18, or connectable to the electronic device by wireless communication 20, as is illustrated in FIG. 2, to provide a tethered interface 22. Referring to FIG. 4, in one presently preferred embodiment, the electronic device may be a digital camera, although the present invention may be used with many other types of electronic devices, as will be further explained below.

As is illustrated in FIGS. 1 and 2, the interactive interface apparatus preferably includes a memory 26 connected to the processor for storing a program for operating the processor, such as a program that may be stored on and loaded in the memory from a storage media 28, such as a CD, DVD, flash media, or any other similar such storage media that may be currently suitable, or from an Internet website link 30, for example. For the optimal teaching/tutoring experience the interactive interface allows for partial or even total computer control of the electronic device, which typically includes some type of operator interface 32 allowing a user to operate or directly communicate with the electronic device, as is further explained below.

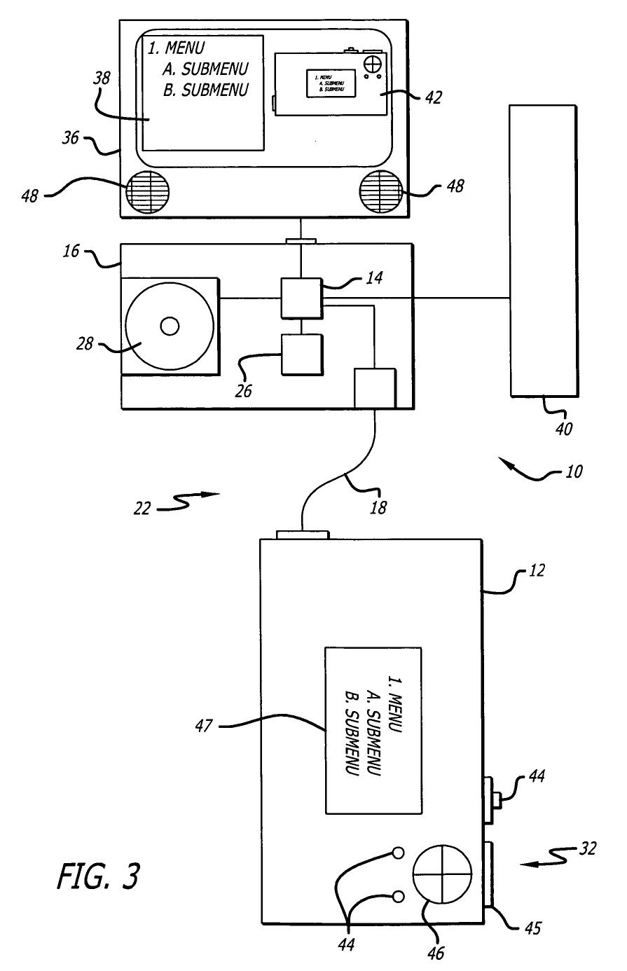

The interactive interface apparatus display 34 is connected to the programmable processor, for control by the program. The display may be integral to the interactive interface apparatus, or as is illustrated in FIG. 3, in a variation, the display may be provided as an external monitor or display 36 to which the interactive interface apparatus may be connected, such as a computer monitor or television, for example. As is shown in FIGS. 1-3, the interactive interface apparatus is typically programmed to present a plurality of instruction menu items 38 displayed on the display, and the interactive interface apparatus includes a user input device 40, such as a keyboard and/or pointing device, for example, for accepting user input and connected to the programmable processor of the interactive interface apparatus to allow the user to select at least one of the plurality of instruction menu items provided on the display, and the programmable processor may also be operative to monitor or poll user input. The program would allow the user, through the interactive interface apparatus, to navigate through an “instruction” or “getting acquainted” menu displayed by the interactive interface apparatus. The user would then be able to proceed sequentially from start to finish or at random through the menu displayed as needed to the desired topic.

The programmable processor and display as controlled by the program will typically prompt the user to select a topic of interest. When the user selects the topic, the program will then guide the user through a simulation, such as an animated two or three dimensional simulation, or a movie, such as a movie of someone demonstrating the electronic device, with visual indications provided on the display of at least a portion 42 of the electronic device required to accomplish a selected function, such as a button 44, a lever 45, a pointing device 46, for example, or one or more menus 47, or combinations thereof, required to accomplish a selected function. The display preferably not only provides a visual display, but also includes a speaker 48 for presenting accompanying sound, such as audio instruction or audio feedback responsive to user input, for example. Each key press, button, lever or submenu activation can thus provide audio beeping, polyphonic tones or verbal feedback, for example, for confirmation, or as an alert when a wrong selection is made.

For devices such as cell phones, satellite TV or other subscription based controllers, the interactive interface apparatus could advantageously place the electronic device in a simulation mode to avoid unintended subscription charges. For cases such as these, the program would enter a simulation mode to simulate things such as incoming telephone calls, multiple incoming calls to simulate call waiting, downloadable subscriptions, or newscasts; pay per view events; other devices on a network such as a smart home network, for example. The simulation mode would thus allow the user to learn the functions through simulated experiences.

Referring to FIG. 4, when the electronic device is a camera, such as a digital camera 50, the programmable processor may be programmed to provide instruction and evaluation of operation of the digital camera, such as for operation of the digital camera for a plurality of scenes, or for a plurality of photographic opportunities, for example. In addition, the programmable processor may receive exchangeable image file format information from the digital camera, so that the programmable processor may be in turn operative to provide instruction and evaluation of operation of the digital camera responsive to the exchangeable image file format information. In a presently preferred aspect, the digital camera includes an internal clock 52 and an operating system 54 that generates time codes 56, such that the programmable processor is operative to synchronize the time codes with operation of the digital camera for evaluation of the operation of the digital camera. The digital camera may also include an input/output interface 58 capable of real-time or near real-time image data capture and transfer, such that the programmable processor is operative to provide closed loop evaluation and instruction responsive to operation of the digital camera. It is contemplated that other similar electronic devices may similarly be configured to include an internal clock and an operating system that generates times codes, so that a programmable processor of the electronic device would synchronize the time codes with operation of the electronic device for closed loop evaluation of the operation of the electronic device, through the interactive interface of the invention.

With the advent of affordable, tethered, digital photography it is now possible to “close the loop” in photography. The loop that will allow simulated imagery to be ranked or graded, analyzed and critiqued for shot selection, motion tracking, composition and framing, zoom, focus of stationary and moving objects, and speed and accuracy. Today, digital cameras send not only the captured image but in addition all the EXIF (Exchangeable Image File Format) information as well as most other parametric information such as focal length, white balance temperature, focus mode, focus point used, and date and time, all on a per shot basis.

Images can be replayed and/or generated and kept track of through a unique and associated time code derived from the Operating System and synchronized with the camera's internal clock. Based on time codes for the generated and captured images photographic performance can now be compared and evaluated for but not limited to focus, framing, reaction time, camera knowledge and familiarity, photographic knowledge, tracking accuracy, hand eye coordination, and shot selection and execution. Since everything can be time coded and repeated endlessly, data can be logged and results compared, tabulated, graphed and graded. Results can be used for the purposes of advancement, recruiting, hiring, selecting, improving and grading photographic performance.

With the advent of new powerful central processing units (CPUs) and camera input/output interfaces (IEEE-1394, USB2, WI-FI, Gigabit Ethernet, Fiber Channel and other emerging data communication protocols) capable of real-time of near real-time image capture and transfer, digital photography/videography is now capable of closed loop system operation and education. Use of a closed loop can now be employed to inform, instruct, train and educate camera users of all types. This closed loop system of instruction allows the use of predetermined parameters or preferences input by the user. User training preferences once entered, can be used by a program to tailor the output, and ultimately the nature or form of training or education presented. User preferences would specify what areas of image capture the user wants to concentrate on.

A program that is capable of replaying video or computer generated imagery on a display device whether desktop or projected would allow a user to read or listen to instructions and then familiarize him or herself with the interface, functions and controls of the camera. A more advanced user might benefit not from instructions related to the use of the camera but could benefit from instructions and drills provided by the software on shooting methodology. An example of such a drill would be the repetitive playback or presentation of video footage on the computer display device of events every photographer dreams of capturing but normally have little or no access to practice capturing other than attending countless games or events. One category of such events would be sports related actions or events that are usually captured by sports magazines but that most often seem to elude all but the most highly trained photographer. Such events are typically very fleeting moments that require very fast reactions, knowledge of the game, anticipation, coaching, proper timing and high shutter speeds to capture properly.

Other drills can provide training and education in the form of experimentation. While many events require large apertures and very high shutter speeds, other scenes or events call for the opposite: small apertures and slow shutter speeds or some combination thereof.

The degree to which the image is blurred is determined by the shutter speed. There is no wrong or right amount. The right amount is determined by the kind of picture the photographer is after and unless and until the photographer has had the opportunity to test or experiment the effects of different shutter speeds and apertures, he may not know what he is after or what is possible. The ability to experiment with different shutter speeds while in the comfort of their living room gives a photographer the opportunity to make note of and learn the settings needed under different conditions.

For modern digital cameras, the interactive interface would be useful in becoming acquainted with white balance adjustments, ISO speed adjustments, photo compression settings, depth of field, focus point selection and use, single shot and multiple shots, shooting modes: manual, fully automatic, aperture priority, shutter priority. color temperature, color filters, and autofocus selection modes. Images can be displayed on the screen to allow the user to photograph them and thus use the white balance function custom white balance function and most other features.

Motion picture capture devices that can feed live video back to a computer can similarly benefit from instructions and drills programmed in the interactive interface of the invention. For modern video recorders (both tape and digital), the interactive interface would be useful in becoming acquainted with record modes, recording speeds, white balance, title safe areas and what they mean, and color casts. Depending on the interface used, the invention could feed video back to the video camera's viewfinder so that the user could again, would not have to seek out the particular scene for him to be able to test out the different settings. If the signal could not be fed directly back to the viewfinder, the video could be displayed on the monitor for the user to record and experiment with.

An interactive interface for other types of electronic devices allows such devices to be controlled or allow interaction with the electronic devices while the interactive interface transmits signals or simulates the needed signals to generate the appropriate, “real world” response. This type of control then allows the user to learn to use the electronic device by actually using the electronic device. Using the electronic device itself to learn would enable the user to become familiar with the functions and features.

For more complex functions the interactive interface would walk the user through more complicated procedures with feedback provided by way of audio cues or visual aids. More esoteric procedures or features might typically be buried under layers of menus and sub-menus, require multiple, simultaneous button presses or dial turning, or require specific timing between steps or button presses. These features could be made much more accessible to the user because once at a final destination, the user could simply store the required steps for future use by assigning it to a user defined function or “soft button,” if available, or as a personal function, and additionally storing the function on the interactive interface as a back up. For example, a user could assign a button or function of a remote control to turn on the home theater system in a certain surround sound mode, drop down the projector screen, turn on the satellite or cable box. A time delay could be built into the command to allow for warm up of projector and the system with the final step being assignment of a widescreen mode for the projector. As another example, for a Personal Digital Assistant (PDA), a user could assign a button or function to open a stored telephone book, pause and allow the user to select a phone number and then dial the number. As a further example, a user could assign a button or function to a cellular phone to access a rarely used function or feature that would normally not be available without digging down into several layers of menus, such as a voice recorder function, or MP3 player capability, which can be made available to a user all at the touch of a button instead of having to remember the buttons, menus and order of key presses.

Through a link to the Internet, users could share codes or files for such saved assigned buttons or functions by uploading them to a web site, along with a description of what the assigned buttons or functions accomplish. Once collections of such assigned buttons or functions are made available on a web site, other users would be able to search through them and download them for use. Either as a supplement to an inadequate user manual, or as a convenience to users who may be too impatient to study long and complicated instructions in a user manual, this type of shared information would not only assist user, but would also allow manufacturers to tap into convenient assigned buttons for documented features as well as previously undocumented features in order to update and improve on their official user manuals.

In addition, the interactive interface of the invention would allow manufacturers to perform remote diagnostics on a costly electronic device that might normally require a user to bring the device to a repair site or an onsite visit from a technician. For example, an electronic device could be provided by the manufacturer with a diagnostic mode that the electronic device could enter when connected to the Internet and logged into the manufacturer's web site for troubleshooting purposes. In order to run such remote diagnostics, there would need to be a remote log-in program, such as a Virtual Network Computing (VNC) program, so that a diagnostic program would be able to analyze the electronic device, connected through the interactive interface of the invention. Automated or semi-automated diagnostics would be possible. The effectiveness of the remote diagnostics that could be rendered to an electronic device would depend upon the effectiveness of the manufacturer's interface design and the level of control that would be allowed to an interactive interface according to the invention. This type of diagnosis could be made part of a service or maintenance contract, and could therefore also become an added benefit to manufacturers and consumers. In the event that service of the electronic device is required, error codes could be conveyed through the interactive interface to allow a technician to be dispatched with proper equipment, or to allow proper replacement parts to be ordered. In addition, the interactive interface of the invention would allow for remote monitoring of operation of an electronic device through a network connection. Such remote monitoring would allow manufacturers and repair facilities to witness failure modes in real time. The remote diagnostics and/or remote Internet log-in capability would further allow fully interactive remote teaching of subjects with electronic devices, such as digital cameras, as well as meters and household appliances, for example, by using remotely generated images and video, and such training may also be automated.

For modern cellular telephones, the interactive interface would be useful in becoming acquainted with multiple built in devices and features, such as MP3 players, cameras, video recorders, text messaging, call waiting, call forwarding, speakerphone, call screening, caller id, Bluetooth/wireless functions, and audio recorder.

For portable navigation systems, the interactive interface could simulate navigational signals so that the user could become familiar with navigational functions without having to be leave the comfort of home. Functions could include entering a destination address, entering a way point, changing route preferences from maximize highway to minimize highway, and changing preferences to shortest distance or shortest time, for example.

The interactive interface of the invention similarly would be useful with all microprocessor controlled or “smart” equipment; medical instruments such as X-ray machines, MRI machines, CT, PT, Gamma knives, X knife, Linear accelerators, blood centrifuge and electronic testing devices or equipment.

The interactive interface of the invention similarly would be useful with digital cable boxes/satellite receivers, as to how to find a station, how to store a station, how to scan or seek a station, how to recall a station, and how to subscribe to a pay per view or pay per listen event or program.

The interactive interface of the invention similarly would be useful with meters such as photographic light meter and volt meters, for example; printers of all types so that users can learn to differentiate between the different printing modes; electron microscopes; automobile smog machines; cash registers; dangerous, high speed equipment such as tire balancers for automobile shops, CNC routers used in machine shops, and tire balancing diagnostics, which can be simulated without having to mount and spin a tire; star tracking telescopes; robotic arms and other industrial equipment; and electronic scales.

The interactive interface of the invention can also be used to train users on more advanced functions once basic functions are mastered. The invention can then be used to measure the extent to which the user can operate the device. This can greatly improve training procedures and effectiveness as well as improve the user experience for consumer products and improved productivity, safety, efficiency for business and industry for commercial testing, diagnostic, point of purchase and medical applications.

The interactive interface of the invention can also be used in game play applications for honing skill sets. For players of video games that would like to get practice coordinating their hand/eye/reaction times. The interface could allow a player to enter into a training mode that would allow repeated replays of scenes they know they need to improve on in order to progress.

Armed forces training could also benefit from the interactive interface of the invention that would allow the user to select exercises that would allow the user to concentrate on drills that would focus on areas that need improvement. Such areas would be reaction times related to objects entering a radar screen from a particular quadrant. Another such example would be to have the user drill on having multiple objects enter simultaneously. Since the video or animations are being generated by the interactive interface of the invention, reaction times and all other pertinent data can be logged and tracked and analyzed. This type of training could add functionality that would allow for much more rapid improvement by concentrating on the weakest performance areas.

Thus, with the interactive interface of the invention, a user who has a weak eye, or simply a poor response when using their left eye, or perhaps poorer aim with their right hand, or in a certain part of a screen or field of view, for example, could select or designate exercises or software to be in a “monitor” or analysis mode that would assess strengths and weaknesses. Such results can then be used to select areas for emphasis in a drill, game or exercise, such as in areas that may be of special importance for military training, for example, that could be repeated for improving performance. The ability of the interactive interface of the invention to provide drills allows users to repeat exercises and keep track of progress without having to play an entire game or go through an entire exercise in order to practice what is needed, thereby allowing users to use their time to efficiently hone needed skills.

It will be apparent from the foregoing that while particular forms of the invention have been illustrated and described, various modifications can be made without departing from the spirit and scope of the invention. Accordingly, it is not intended that the invention be limited, except as by the appended claims.

I claim:

1. An interactive interface apparatus for an electronic device, comprising:
a programmable processor connectable in communication with an electronic device for at least partially controlling operation of the electronic device and for monitoring operation of the electronic device;
a memory connected to the processor for storing a program for operating the processor;
a user input device for accepting user input, the user input device connected to said programmable processor; and
a display connected to the programmable processor.

2. The interactive interface apparatus of claim 1, wherein said programmable processor is operative to provide total control of the electronic device.

3. The interactive interface apparatus of claim 1, wherein said programmable processor comprises a computer.

4. The interactive interface apparatus of claim 1, wherein said programmable processor is connectable to the electronic device by an electrical connector.

5. The interactive interface apparatus of claim 1, wherein said programmable processor is connectable to the electronic device by wireless communication.

6. The interactive interface apparatus of claim 1, wherein said interactive interface is a tethered interface.

7. The interactive interface apparatus of claim 1, wherein the electronic device comprises a digital camera.

8. The interactive interface apparatus of claim 1, wherein the electronic device comprises a video camera.

9. The interactive interface apparatus of claim 1, wherein the program is stored on storage media.

10. The interactive interface apparatus of claim 1, wherein the program is provided on an Internet website.

11. The interactive interface apparatus of claim 1, wherein said display is selected from the group consisting of an internal display, an external display, a television, a projector, a plasma display, and combinations thereof.

12. The interactive interface apparatus of claim 1, wherein said display comprises a plurality of instruction menu items displayed on the display.

13. The interactive interface apparatus of claim 12, wherein the user input device is operative to accept user input for selecting at least one of the plurality of instruction menu items.

14. The interactive interface apparatus of claim 1, wherein the programmable processor is operative to monitor user input.

15. The interactive interface apparatus of claim 1, wherein the programmable processor and display are operative to provide a simulation of the electronic device.

16. The interactive interface apparatus of claim 15, wherein said simulation comprises an animated simulation.

17. The interactive interface apparatus of claim 15, wherein said simulation comprises a movie.

18. The interactive interface apparatus of claim 16, wherein said animated simulation comprises visual indications of at least a portion of the electronic device required to accomplish a selected function.

19. The interactive interface apparatus of claim 18, wherein said at least a portion of the electronic device comprises a button.

20. The interactive interface apparatus of claim 18, wherein said at least a portion of the electronic device comprises a lever.

21. The interactive interface apparatus of claim 16, wherein said animated simulation comprises a visual indication of at least one menu required to accomplish a selected function.

22. The interactive interface apparatus of claim 17, wherein said movie comprises a visual indication of at least a portion of the electronic device required to accomplish a selected function

23. The interactive interface apparatus of claim 17, wherein said movie comprises a movie illustrating demonstration of the electronic device.

24. The interactive interface apparatus of claim 1, wherein the programmable processor and display are operative to provide audio feedback responsive to said user input.

25. The interactive interface apparatus of claim 1, wherein the programmable processor and display are operative to provide audio feedback responsive to operation of the electronic device.

26. The interactive interface apparatus of claim 1, wherein the electronic device is subject to subscription service charges for operation of the electronic device, and the programmable processor is operative to control the electronic device in a simulation mode avoiding subscription charges.

27. The interactive interface apparatus of claim 7, wherein the programmable processor is operative to provide instruction and evaluation of operation of the digital camera.

28. The interactive interface apparatus of claim 7, wherein the programmable processor is operative to provide instruction and evaluation of operation of the digital camera for a plurality of scenes.

29. The interactive interface apparatus of claim 7, wherein the programmable processor is operative to provide instruction and evaluation of operation of the digital camera for a plurality of photographic opportunities.

30. The interactive interface apparatus of claim 7, wherein the programmable processor receives exchangeable image file format information from the digital camera, and the programmable processor is operative to provide instruction and evaluation of operation of the digital camera responsive thereto.

31. The interactive interface apparatus of claim 1, wherein the electronic device comprises an internal clock and an operating system generating time codes, and wherein the programmable processor is operative to synchronize the time codes with operation of the electronic device for evaluation of the operation of the electronic device.

32. The interactive interface apparatus of claim 7, wherein the digital camera includes an input/output interface capable of real-time or near real-time image data capture and transfer, and the programmable processor is operative to provide closed loop evaluation and instruction responsive to operation of the digital camera.

33. The interactive interface apparatus of claim 1, wherein programmable processor is provided with a plurality of predetermined parameters input by the user input device.

34. A method for at least partially controlling an electronic device and for monitoring operation of the electronic device via an interactive interface, comprising the steps of:
providing an interactive interface apparatus including a programmable processor connectable in communication with the electronic device, a memory connected to the processor for storing a program for operating the processor, a user input device connected to said programmable processor for accepting user input, and a display connected to the programmable processor;
operatively connecting the interactive interface to the electronic device;
displaying a plurality of instruction menu items on the display;
receiving user input from the user input device to allow a user to select at least one of the plurality of instruction menu items provided on the display; and
displaying a simulation of operation of the electronic device to accomplish a selected function.

35. The method of claim 34, further comprising the step of monitoring said user input.

36. The method of claim 34, further comprising the step of displaying a simulation of operation of the electronic device to accomplish a selected function.

37. The method of claim 36, wherein said step of displaying a simulation comprises providing audio instruction responsive to said user input.

38. The method of claim 34, wherein the electronic device includes an internal clock and an operating system that generates time codes, and further comprising the step of synchronizing the time codes with operation of the electronic device for evaluation of the operation of the electronic device.

39. The method of claim 34, further comprising the step of providing closed loop instruction responsive to operation of the electronic device.

40. The method of claim 34, further comprising the step of storing a user defined function in the interactive interface.

41. The method of claim 40, further comprising the step of uploading user defined function to an Internet web site.

42. The method of claim 34, further comprising performing remote diagnostics on the electronic device via the interactive interface.
